(19) United States
(12) Patent Application Publication
(10) Pub. No.: US 2006/0266300 A1
(43) Pub. Date: Nov. 30, 2006

(54) Retracting pet leash assembly

(76) Inventor: Jerzy Perkitny, Lakewood, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 11/440,946

(22) Filed: May 25, 2006

Related U.S. Application Data
(60) Provisional application No. 60/684,506, filed on May 25, 2005.

(51) Int. Cl. A01K 37/00

(52) U.S. Cl. 119/713

(57) ABSTRACT

The present invention relates to a puller operably connected to an associated pet leash for enabling a pet owner to retract the associated pet leash. The puller comprises a housing and first and second locking elements mounted in the housing. The second locking element is spaced a predetermined distance from the first locking element to allow the associated pet leash extending through the housing to pass therebetween. A trigger assembly is operatively mounted to the housing. A first portion of the trigger assembly engages the first locking element. As the trigger assembly is depressed, the first locking element engages the associated pet leash and presses the associated pet leash against the second locking element thereby preventing movement of the associated pet leash through the puller, in at least a first direction.

### CROSS REFERENCE TO RELATED PATENTS AND APPLICATIONS

This application claims priority from U.S. Provisional Patent Application Ser. No. 60/684,506 filed May 25, 2005 and is incorporated herein by reference.

### BACKGROUND OF THE INVENTION

The present invention relates, generally, to a restraining device for a pet. More particularly, the present invention relates to a puller for a retracting pet leash that allows the user to manually control a pet without injury.

Pet owners commonly restrain their pets using leashes. The typical leash includes an elongated strap or braided nylon cord having, at one end, a loop or handle for grasping by the pet owner and, at the other end, a clasp that attaches the leash to the pet's collar. One common type of leash is the retractable leash. This design employs a housing having a mechanism (e.g. a spring-driven mechanism) for automatically retracting the leash into the housing for shortening the leash cord and for storing the leash cord when the leash is not in use. Such leashes can provide effective means of restraining a pet during simple “walks” or during training.

Retractable pet leashes generally enable the user having a pet tethered to a leash cord to fluidly adapt to changing spatial relationships between the user and the pet. Conventionally, retractable leash assemblies generally operate in two modes. A first mode provides a spring loaded tension on the retractable leash cord. The spring-loaded tension causes the leash cord to retract as slack develops, to stop the leash from dragging on the ground, and extends as the pet pulls on it to roam at a further distance. A second, locking, mode removes the spring-loaded tension and stops the leash from either retracting or extending.

One disadvantage of traditional retractable pet leash assemblies is that the switching mechanism for selecting between a spring-loaded tension mode and a locked mode of operation is somewhat clumsy to operate. Some prior systems require a constant force to be applied to a braking mechanism to maintain the leash cord in a locked mode. In other conventional retractable pet leash assemblies, the locked mode is maintained by applying a locking pin to the brake mechanism. Quite often such leash assemblies require the use of both hands, or require difficult single-handed motions to transit between the locked and spring-loaded tension modes of operation.

Moreover, conventional leash assemblies do not enable a pet owner to retract the leash into the housing when the pet exerts more tension on the leash than the retraction force supplied by the spring bias on the spool on which the leash is wrapped. The pet owner has to manually grasp the leash to pull the pet towards him, causing slack in the line, thereby allowing the spring driven mechanism to retract the leash. But, grasping the leash may injure the owner's hand, particularly when the pet is pulling strongly on the leash.

In light of the foregoing, it becomes evident that there is a need for a retractable pet leash assembly that would provide a solution to one or more of the deficiencies from which the prior art and/or conventional leash assemblies have suffered.

### BRIEF DESCRIPTION OF THE INVENTION

In accordance with one aspect of the present disclosure, a puller is operably connected to an associated pet leash for enabling a pet owner to retract the associated pet leash. The puller comprises a housing and first and second locking elements mounted in the housing. The second locking element is spaced a predetermined distance from the first locking element to allow the associated pet leash extending through the housing to pass therebetween. A trigger assembly is operatively mounted to the housing. A first portion of the trigger assembly engages the first locking element. As the trigger assembly is depressed, the first locking element engages the associated pet leash and presses the associated pet leash against the second locking element thereby preventing movement of the associated pet leash through the puller, in at least a first direction.

In accordance with another aspect of the present invention, a puller operably connected to an associated pet leash for enabling a pet owner to retract the associated pet leash, comprises a puller housing. A lock housing is mounted to the puller housing. The lock housing includes a channel dimensioned to slidingly receive the associated pet leash. A trigger assembly is operatively mounted to the lock housing. A first locking element is rotatably mounted to the trigger assembly. A second locking element is mounted to the lock housing.

In accordance with yet another aspect of the present invention, a retractable pet leash assembly comprises a housing and a spool rotatably mounted to the housing. A stop member extends from the housing. The stop member includes a first surface and a second surface. A trigger assembly is operably mounted in the housing. The trigger assembly includes a locking member configured to selectively engage the stop member and an inhibitor connected to the locking member. The inhibitor selectively engages the spool. In a first position, the locking member is spaced from the stop member and the inhibitor is spaced from the spool. The spool freely rotates within the housing. In a second position, the locking member engages the first surface of the stop member. The inhibitor at least partially engages the spool and prevents the spool from rotating in a counterclockwise direction. In a third position, the locking member engages the second surface of the stop member. The inhibitor engages the spool and prevents the spool from rotating in either a clockwise direction or a counterclockwise direction.

Still other non-limiting aspects of the present invention will become apparent from a reading and understanding of the description of the preferred embodiments hereinbelow.

### BRIEF DESCRIPTION OF THE DRAWINGS

The present invention may take physical form in certain parts and arrangements of parts, preferred embodiments of which will be described in detail in this specification and illustrated in the accompanying drawings which form a part hereof.

FIG. 1 is a right side perspective view of a retracting pet leash according to a first embodiment of the present invention.

FIG. 2 is a front exploded perspective view of the retracting pet leash of FIG. 1.

FIG. 3 is a right side elevational view of the retracting pet leash of FIG. 1 with a housing half removed showing a first position of a trigger assembly of the retracting pet leash, an inhibitor of the trigger assembly partially engaging a spool of the retracting pet leash thereby allowing rotation of the spool in only one direction.

FIG. 4 is a right side elevational view of the retracting pet leash of FIG. 3 with a housing half removed showing a second position of the trigger assembly of the retracting pet leash.

FIG. 5 is a right side elevational view of the retracting pet leash of FIG. 3 with a housing half removed showing a third position of the trigger assembly of the retracting pet leash, the inhibitor of the trigger assembly fully engaging the spool of the retracting pet leash thereby preventing rotation of the spool in either direction.

FIG. 6 is a right side elevational view of the retracting pet leash of FIG. 3 with a housing half removed showing a fourth position of the trigger assembly of the retracting pet leash.

FIG. 7 is a right side elevational view, partially broken away, of the retracting pet leash assembly of FIG. 1 showing the spool of the retracting pet leash in a freely rotating, condition.

FIG. 8 is a rear perspective view of a puller for a retracting pet leash according to a first embodiment of the present invention.

FIG. 9 is an exploded front perspective view of the puller of FIG. 8.

FIGS. 10 and 12 are each right side perspective views of the puller of FIG. 8 with a housing half removed showing a first position of a trigger assembly of the puller.

FIGS. 11 and 13 are each right side perspective views of the puller of FIG. 8 with a housing half removed showing a second position of the trigger assembly of the puller.

FIGS. 14-19 are right side perspective views of the puller of FIG. 8 showing the operation of the puller.

FIG. 20 is a right side perspective view of a puller for a retracting pet leash according to a second embodiment of the present invention.

FIG. 21 is an exploded front perspective view of the puller of FIG. 20.

FIG. 22 is a right side perspective view of the puller of FIG. 21 with a housing half removed showing a second position of a trigger assembly of the puller.

FIG. 23 is a right side perspective views of the puller of FIG. 21 with a housing half removed showing a first position of the trigger assembly of the puller.

FIG. 24 is a right side elevational view of a retracting pet leash according to a second embodiment of the present invention.

FIG. 25 is a right side elevational view of the retracting pet leash of FIG. 24 with a housing half removed showing a first position of a stop and a trigger assembly of the retracting pet leash, an inhibitor of the trigger assembly partially engaging a spool of the retracting pet leash thereby allowing rotation of the spool in only one direction.

FIG. 26 is a right side view of the retracting pet leash of FIG. 24 with a housing half removed showing a second position of the stop and the trigger assembly of the retracting pet leash, the inhibitor of the trigger assembly fully engaging the spool of the retracting pet leash thereby preventing rotation of the spool in either direction.

FIG. 27 is a right side elevational view of the retracting pet leash of FIG. 24 with a housing half removed showing the spool of the retracting pet leash in a freely rotating, condition.

FIG. 28 is a right side perspective view of a puller for a retracting pet leash according to a third embodiment of the present invention.

FIG. 29 is an exploded front perspective view of the puller of FIG. 28.

FIG. 30 is a right side elevational view of the puller of FIG. 28 with a housing half removed.

### DETAILED DESCRIPTION OF THE INVENTION

The description and drawings herein are merely illustrative of several embodiments of the invention. Various modifications and changes can be made to the components and arrangement(s) of components without departing from the spirit of the invention. Like numerals refer to like parts throughout the several views.

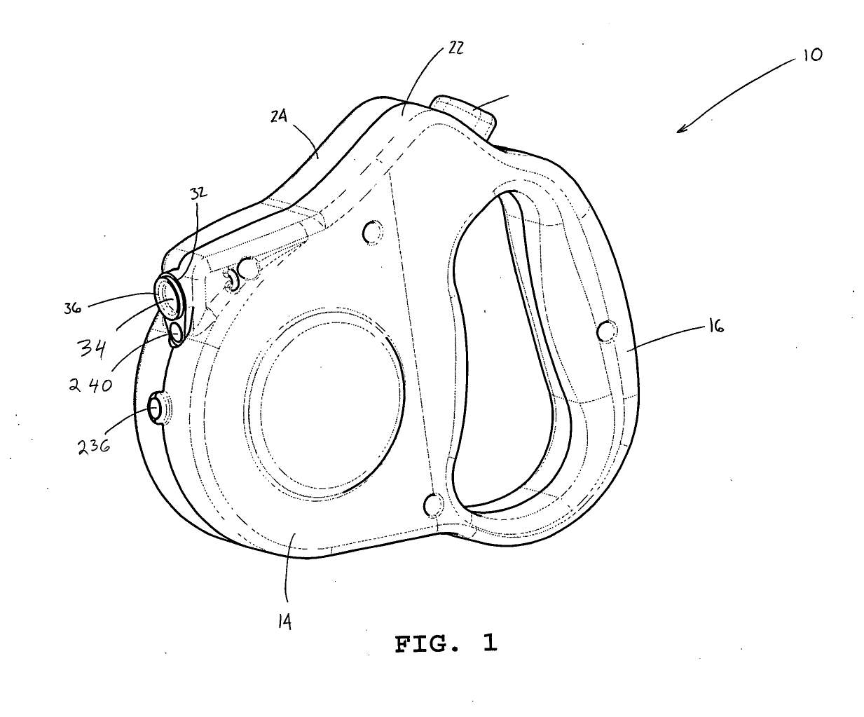

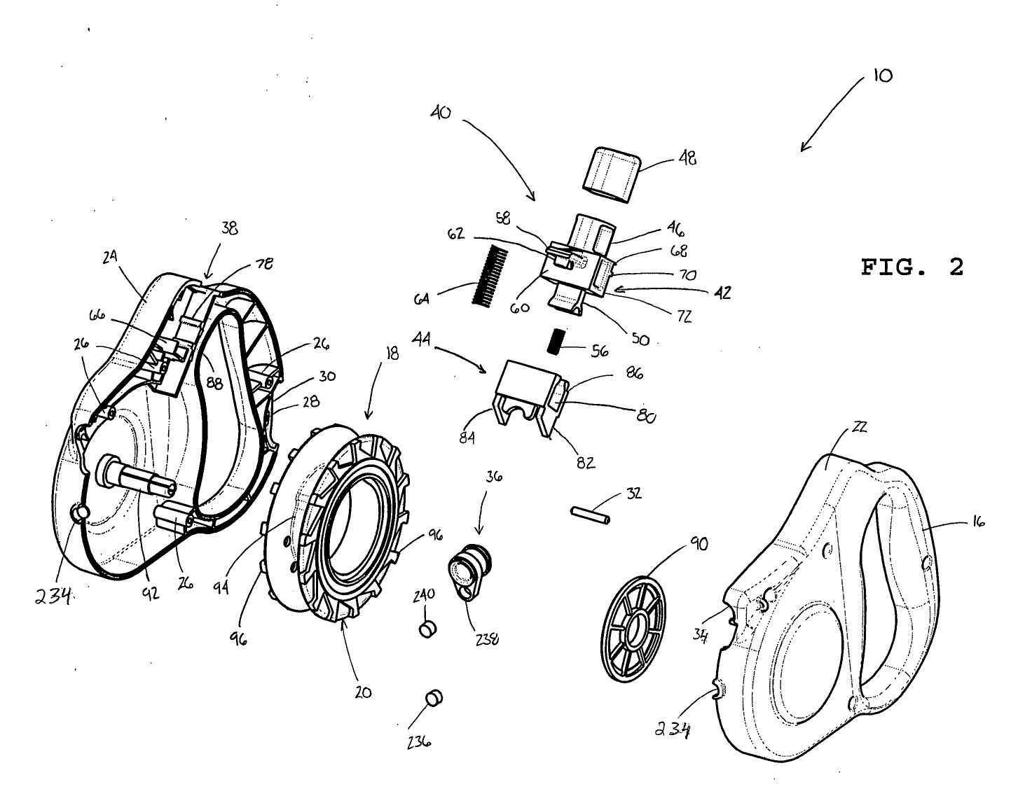

With reference to FIG. 1, a retracting pet leash 10 according to a first embodiment is illustrated. The retracting pet leash generally includes a length of leash (not shown), such as a cord, rope, chain, belt and/or a webbing strip, and a housing 14. The housing 14 includes an ergonomical handle or hand grip portion 16 which can be integrally fabricated with the housing. With reference now to FIG. 2, the retracting pet leash 10 further includes a spool 18 which houses a portion of a spooling mechanism 20. Such spooling mechanism enables the extension and retraction of the leash.

The housing 14 can be a plastic molded component and includes first and second halves 22 and 24 that may be secured together by suitable fasteners. In this embodiment, a plurality of corresponding first bosses 26 extend outwardly from the housing halves 22, 24, each first boss including an aperture for receiving a fastener (not shown) which threadingly engages the aperture. A pair of second bosses 28 extend outwardly from an opening 30 located in the handle portion 16, each second boss including an aperture for receiving a pin 32. A hook (not shown) can be clipped to the pin which allows the operator to attach other items, such as keys or a conventional leash, to the retracting pet leash 10.

A leash opening 34 is provided in a forward facing portion of the housing 14 to enable unhindered movement of the leash between the interior and exterior of the housing. An anti-wear ring 36, which can be made from a lubricious material, such as nylon, can be mounted in the leash opening 34 for buffering the leash through the opening 34 to reduce the frictional wear on the leash due to the leash rubbing against the portion of the housing 14 defining the opening 34. The anti-wear ring 36 can also inhibit the leash from forcing the housing halves 22 and 24 apart during extension and retraction of the leash.

With continued reference to FIG. 2, the housing 14 further includes an opening 38 provided for passage of a trigger assembly 40 operatively mounted to the housing 14 that can engage the spool. The trigger assembly includes a generally rectangular member 42 and an inhibitor 44. Extending from a top wall of the rectangular member is a cap 46 dimensioned to receive a cap button 48. The cap and the cap button extend outwardly from the opening 38 of the housing 14. Extending from a bottom wall of the rectangular member 42 is a generally Y-shaped projection 50, a curved portion of the projection including a button (not shown). A first spring 56 is secured on the button for biasing the inhibitor 44 in and out of engagement with the spooling mechanism 20. The rectangular member 42 further includes a tab 58 extending generally normal to a first side wall 60. A button 62 extends from a bottom surface of the tab 58. A second spring 64 for biasing the trigger assembly 40 has a first end mounted on the button 62 and a second end secured in a channel 66 extending outwardly from the housing half 24. On an opposite surface of the rectangular member from the tab 58 are located first and second flanges 68 and 70 which extend generally normal from a second side wall 72 of the rectangular member 42. The first and second flanges 68, 70 define a channel dimensioned to receive a first tab 78 extending into the opening 38 defined by the housing halves 22 and 24.

As shown in FIG. 2, the inhibitor 44 includes a channel 80 dimensioned to receive the generally Y-shaped projection 50 of the rectangular member 42 and a pair of tabs 82 and 84. The tabs extends generally normal from a bottom wall of the inhibitor 44. As will be explained in greater detail below, the tabs 82, 84 engage the spooling mechanism 20 thereby preventing the free rotation of the spooling mechanism.

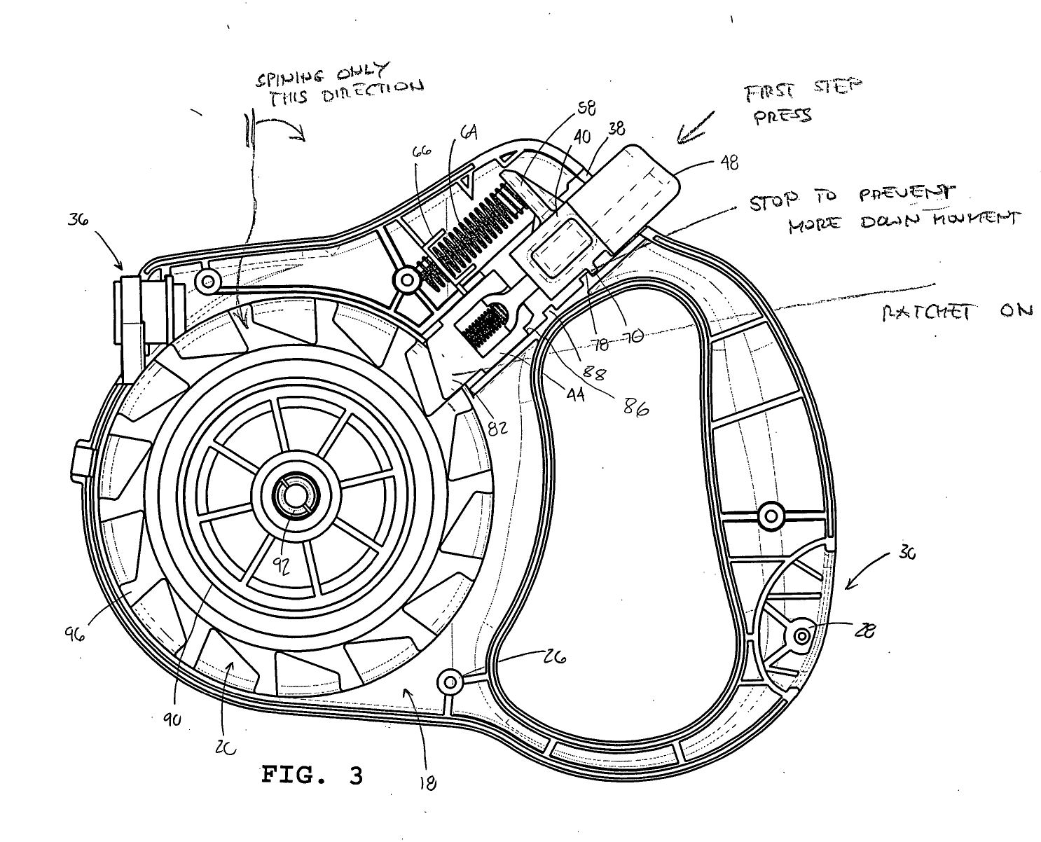

To assemble the trigger assembly, the first spring 56 is attached onto the button (not shown) of the curved portion of the generally Y-shaped projection 50. The rectangular member 42 is then mounted to the inhibitor 44 by sliding the generally Y-shaped projection 50, including the attached first spring 56, into the channel 80 of the inhibitor. Thus, the inhibitor 44 is biased away from the rectangular member 42 as much as is allowed by the interconnection of these two elements (see FIG. 3). The second spring 64 is then mounted on the button 62 of the tab 58. The trigger assembly is positioned in the opening 38 such that the channel defined by the first and second flanges 68, 70 is located above the first tab 78 and a shelf 86 of the inhibitor 44 is located below a second tab 88 also extending into the opening 38 defined by the housing halves 22 and 24 (FIG. 2). It should, be appreciated that the second tab 88 acts as a stop thereby preventing the outward movement of the inhibitor 44 in the opening 38. As can be seen from FIG. 3, the second end of the spring 64 is received in the channel 66 of the housing half 24. The cap button 48 is then positioned onto the cap 46.

It should be appreciated that the location of the trigger assembly 40 enables a user to actuate the trigger assembly with a thumb, while using the remaining fingers of the grasping hand to hold onto the grip portion 16. Actuating the trigger assembly 40 inhibits the leash from extending from the housing 14.

With continued reference to FIG. 2, the spooling mechanism 20 includes a power spring (not shown) and a spool cover 90. A stationary axle 92 extends from the housing half 24. A radially outer end (not shown) of the power spring attaches to the spool 18 to fasten the power spring in a rotatable spool cavity (not shown). The spool 18 and the attached power spring fit onto the axle 92. When mounted on the axle, a radially inner end (not shown) of the power spring is secured to a portion of the axle 92. The spool cover 90 fastens over the power spring to secure the power spring in the spool cavity. The power spring is initially coiled to spring bias the spool 18 to retract the leash. Additionally, as the spool rotates to extend the leash out of the housing 14, the power spring coils further, thereby providing additional retracting bias as the extended portion of the leash increases. The outer surface 94 of the spool 18 is adapted for spooling the leash.

The spool 18 includes several teeth 96 spaced around the circumference of an outer facing portion and the circumference of an inner facing portion of the spool. The teeth 96 are adapted for engaging the pair of tabs 82 and 84 of the inhibitor 44 of the trigger assembly 40.

The engagement of the trigger assembly 40 and the spool 18 is illustrated in FIGS. 3-7. In a first position, as shown in FIG. 3, the trigger assembly 40 is only partially depressed. In this first position, the second flange 70 of the rectangular member 40 abuts against the first tab 78. The teeth 96 of the spooling mechanism 20 are not fully engaged by the pair of tabs 82 and 84 of the inhibitor 44. Rather, in this first position, the spool 18 is free to rotate in a clockwise direction, the spring 56 biasing the inhibitor 44 in and out of engagement with the teeth 96. But, the spool 18 is prevented from rotating in a counterclockwise direction. As such, the leash can retract but will not extend any farther from the housing 14.

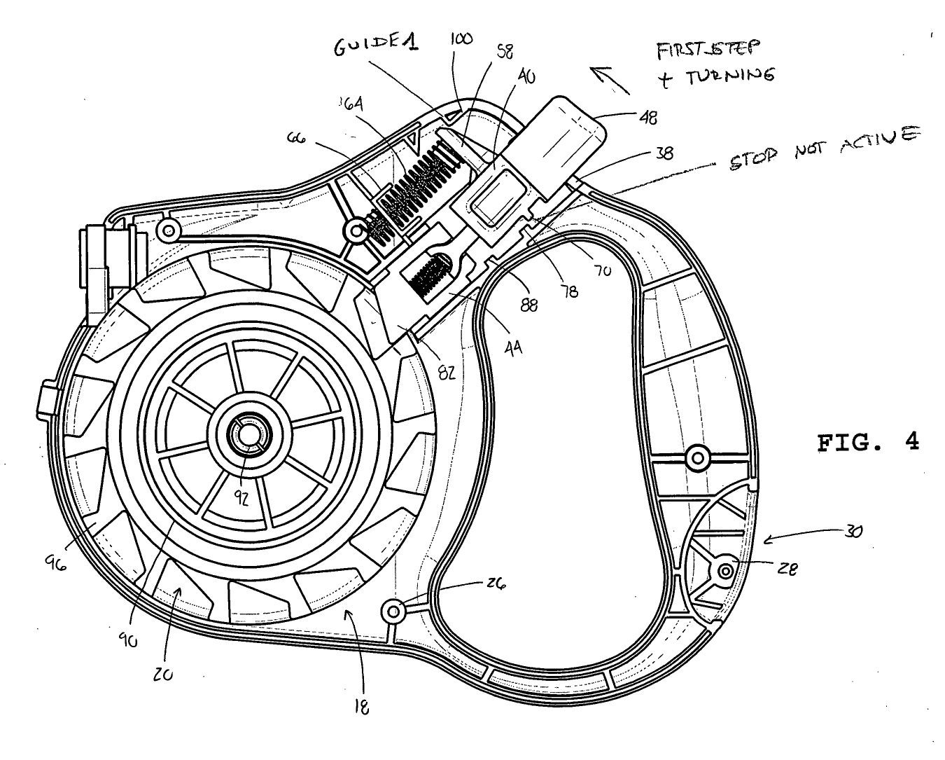

As shown in FIG. 4, the position of the trigger assembly 40 relative to the teeth 96 of the spooling mechanism 20 is similar to that of FIG. 3. However, in this second position, the trigger assembly 40 is pushed forward thereby moving the second flange 70 of the rectangular member 40 off the first tab 78. This forward movement also moves the tab 58 of the rectangular member 40 past a first guide 100 extending inward from a top portion of each housing half 22 and 24.

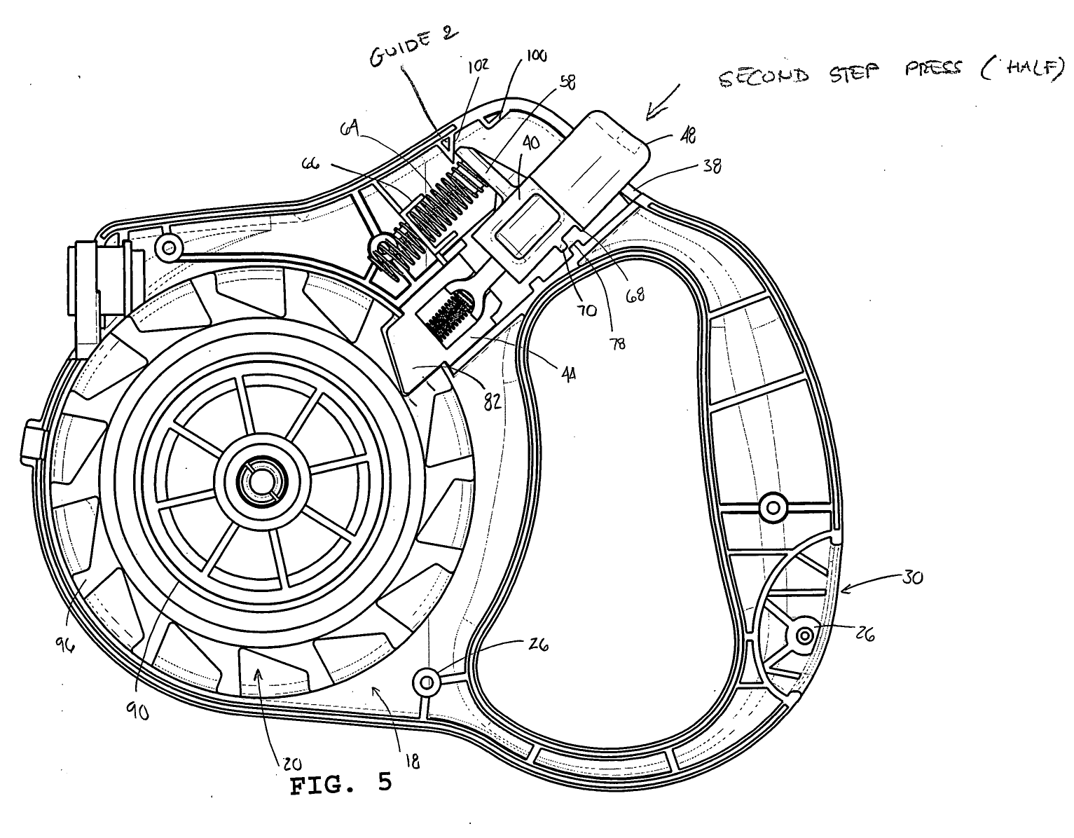

With reference now to FIG. 5, the trigger assembly 40 is shown as moving toward a fully depressed position. In this third position, the trigger assembly is still in the forward position of FIG. 4; however, the first tab 78 is located between the first and second flanges 68, 70 of the rectangular member 40. As the tab 58 of the rectangular member 40 comes into contact with a second guide 102 also extending inward from a top portion of each housing half 22 and 24 it is urged to pivot clockwise, due to the sloping upper surface of the guide. The teeth 96 of the spooling mechanism 20 are fully engaged by the pair of tabs 82 and 84 of the inhibitor 44. Thus, in this third position, the spool 18 is prevented from rotating in either a clockwise direction or a counterclockwise direction.

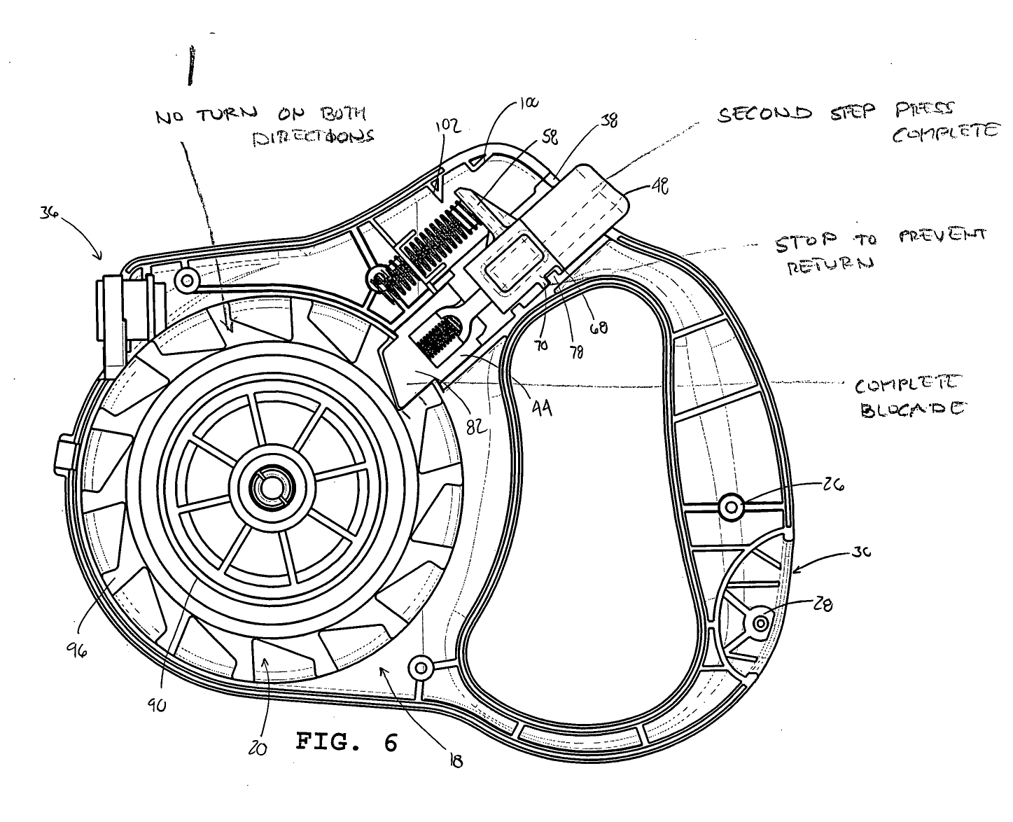

As shown in FIG. 6, the trigger assembly is now in its fully depressed, fourth position since the trigger assembly is moved back from the forward position shown in FIG. 5. The first tab 78 is located in the channel defined by the first and second flanges 68, 70 of the rectangular member 40. Thus, the second flange 70 abuts a bottom surface of the tab 78 thereby locking the trigger assembly 40 into engagement with the spooling mechanism 20.

When the trigger assembly 40 is pushed forward, the second flange 70 will no longer contact the first tab 78 and the spring 64 will bias the rectangular member 42 upwardly. The cap button 48 will now protrude fully from the housing 14. As shown in FIG. 7, the trigger assembly 40 is not depressed and the first and second tabs 82, 84 of the inhibitor 44 are spaced from the teeth 96 of the spooling mechanism 20. As such, in this position, the spool 18 can freely rotate in the housing 14. It should be appreciated that the inhibitor 44 can only move upwardly as far as it is permitted by the second tab 88.

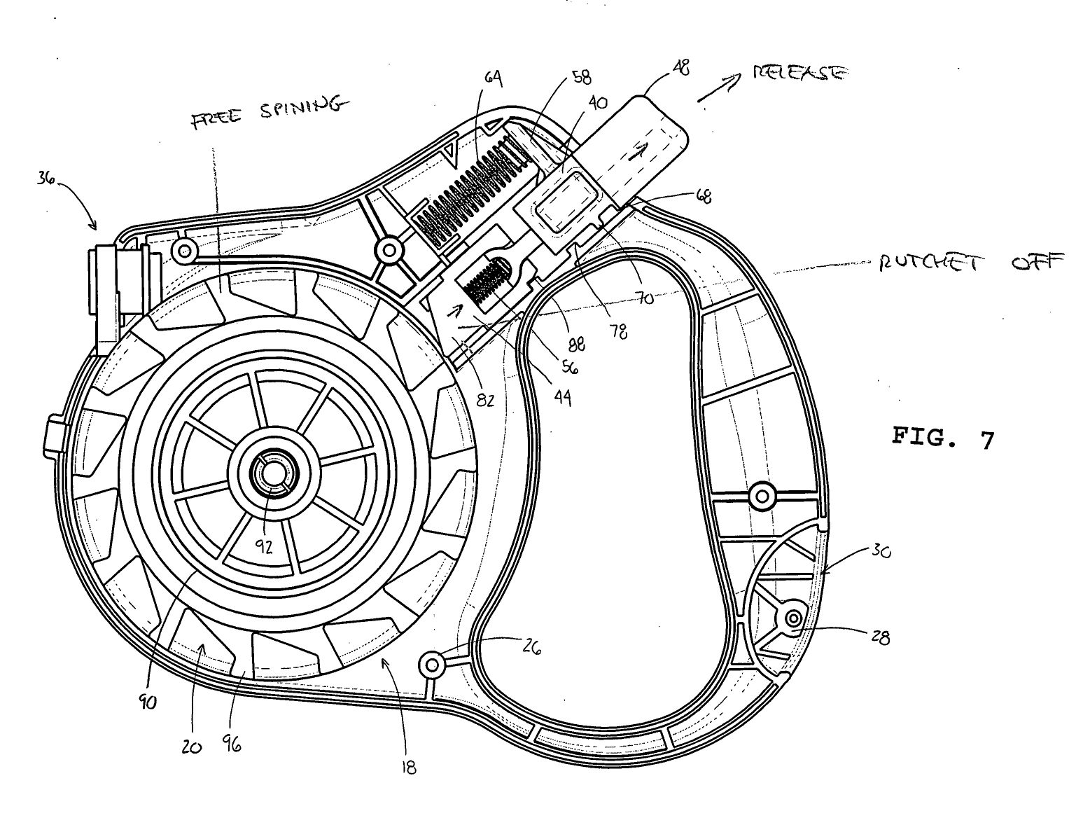

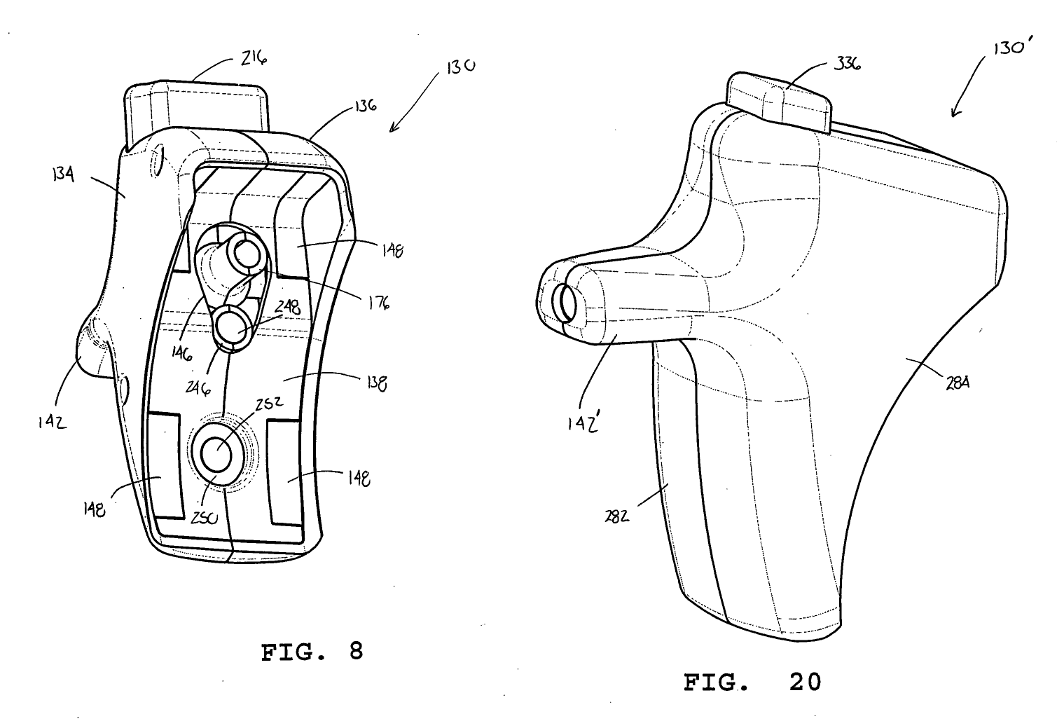

With reference now to FIGS. 8-19, a puller 130 according to a first embodiment of the present invention is shown for a retracting pet leash. The pet leash can be of the type shown in FIGS. 1-7, or of any known type. In other words, the puller 130 can be employed with conventional pet leash assemblies or the retracting pet leash 10 shown in FIGS. 1-7.

With reference to FIG. 9, the puller 130 comprises a housing 132, which can be a plastic molded component, including first and second halves 134 and 136 and a back plate 138. The housing halves may be secured together by suitable fasteners F. In this embodiment, a plurality of corresponding first bosses 140 extend outwardly from the housing halves 134, 136, each boss including an aperture for receiving a conventional fastener F which threadingly engages the aperture. The housing 132 further includes a hollow stem 142 extending outwardly from a forward facing portion 144. As will be described in greater detail below, the stem 142 allows a user to easily grasp the puller 130.

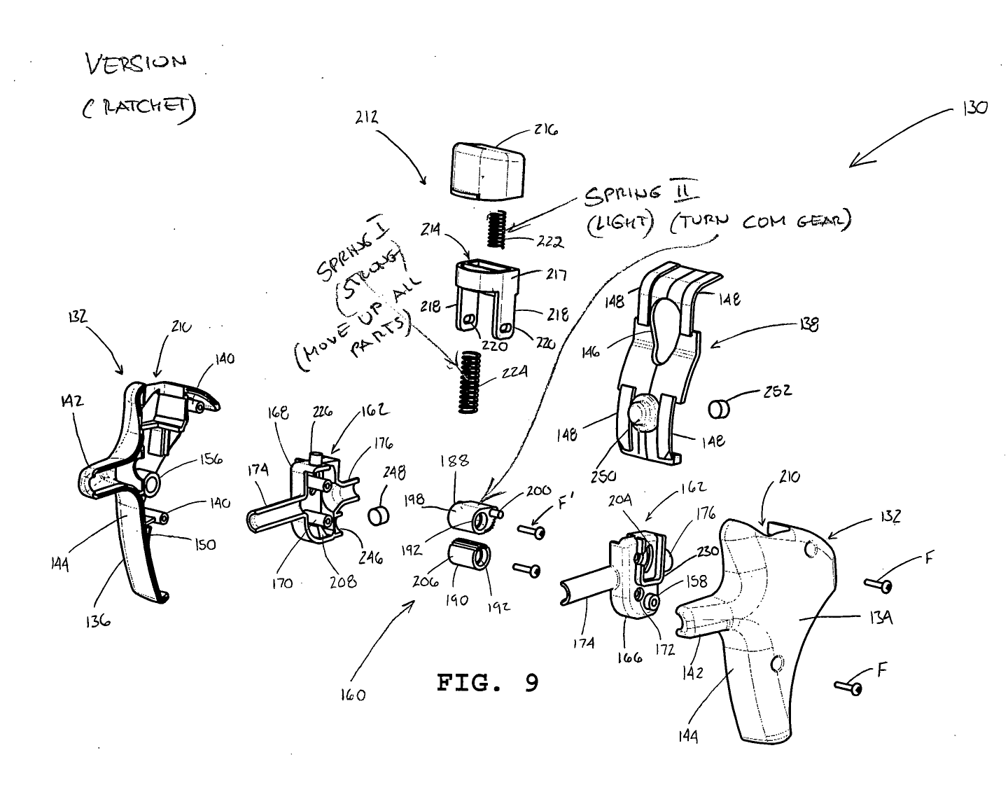

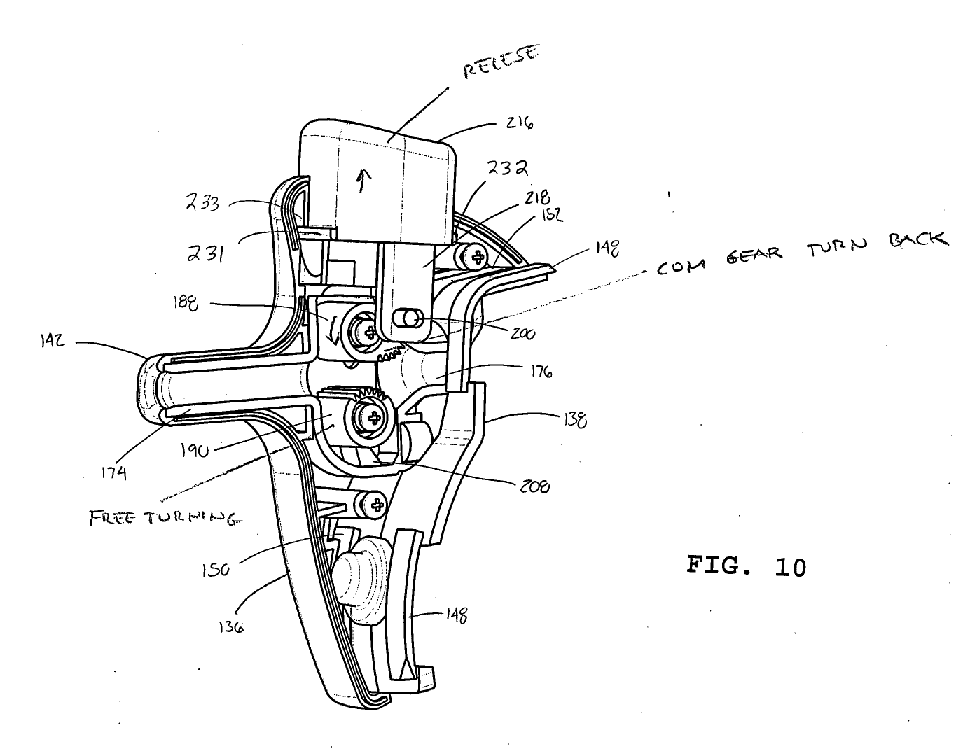

The back plate 138 has a contour conforming to the forward facing portion of the housing 14 and includes an opening 146 dimensioned to receive a portion of the anti-wear ring 36. With additional reference to FIG. 10, to mount the back plate 138 to the housing halves 134, 136, the back plate is provided with thin walled portions 148 which are dimensioned to be received in corresponding first and second slots 150 and 152, respectively, located on each housing half.

With continued reference to FIG. 9, a pair of second bosses 156 also extend outwardly from each housing half 134, 136, each second boss including an aperture for receiving a corresponding projection 158 of a puller mechanism 160. The puller mechanism 160, which can be a plastic molded component, includes a housing 162 having first and second halves 166 and 168, respectively. A pair of bosses 170 extend outwardly from the second housing half 168, each boss including an aperture for receiving a suitable fastener F′ which threadingly engages the aperture through a pair of openings 172 located on the first half 166. The housing 162 further includes first and second generally tubular members 174 and 176, respectively, extending outwardly from respective forward and rear facing portions. It should be appreciated that the first and second tubular members have coincident center axes and an inner diameter dimensioned to slidingly receive the leash (not shown). However, it should be appreciated that when a belt leash is used, the members 174 and 176 could be generally rectangular in shape instead of being tubular. The first tubular member 174 is received in the hollow stem 142. The second tubular member 176 projects outwardly from the opening 146 of the back plate 138 into the opening of the anti-wear ring 36.

The puller mechanism 160 further comprises a first locking element 188 and a second locking element 190. Each of these includes an opening 192 having a diameter slighter larger than an outer diameter of each boss 170. The first locking element 188, which is rotationally mounted on the boss, includes an outer surface 198 having teeth disposed circumferentially about a portion of the outer surface. A pair of pegs 200 extends outwardly from opposing faces of the first locking element. The pegs 200 are received in corresponding generally arcuate slots 204 (FIG. 12) located on the first and second halves 166 and 168 of the housing 162.

The second locking element 190, which is fixed on the boss 170, also includes an outer surface 206 having teeth disposed circumferentially about a portion of the outer surface. As shown in FIG. 10, to fix the second locking element 190 on the boss 170, the second locking element includes an axial recess (not shown) disposed on the outer surface 206 which is adapted to receive a tab 208 projecting from a bottom surface of the housing half 168. As the second locking element 190 is slid onto the boss 170, the tab 208 is received in the recess and the teeth of the second locking element are fixed facing a trigger assembly 212.

With reference again to FIG. 9, the housing 132 further includes an opening 210 provided for passage of a trigger assembly 212 operatively mounted to the housing 132, that can engage the first locking element 188. The trigger assembly includes a cap 214 dimensioned to receive a cap button 216. These extend outwardly from the opening 210 of the housing 132. The cap includes a base 217 and a pair of arms 218, having slotted openings 220, extending generally normal from a bottom surface of the base. The base 217 includes a projection (not shown). A first spring 222 has a first end mounted on the base projection and a second end mounted on a corresponding first projection (not shown) extending from the cap button 216. The first spring biases the cap button relative to the cap. A second spring 224 is employed for biasing the cap in the opening 210. It has a first end mounted on a projection 226 extending from the housing 162 and a second end mounted on a corresponding second projection (not shown) extending from the cap button 216.

To assemble the puller 130, the puller mechanism 160 is first assembled. To this end, the first locking element 188 is slid onto the upper boss 170 such that one of the pegs 200 extends through the arcuate slot 204 of the second housing half 168. The second locking element 190 is slid onto the lower boss 170. The first housing half 166 is then secured to the second housing half by the fasteners F′, the opposing peg 200 extending through the arcuate slot 204 of the first half 168. The first and second springs 222 and 224 of the trigger assembly 212 are then attached to the puller mechanism 160 in the manner described above. The pair of arms 218 of the cap 214 is attached to the housing 162 by securing portions of the opposing pegs 200 of the first locking element 188 extending through the arcuate slots 204 in the slotted openings 220 of the arms. To assist in the securing of the arms to the housing halves 166 and 168, each housing half can include a guide 230 having a contour similar to each arm 218, extending from side portions of the housing half. The puller mechanism 160 with the trigger assembly 212 is finally positioned in the housing halves 134, 136, the housing halves being fastened together by the fasteners F.

It should be appreciated that the location of the trigger assembly 212 enables a user to actuate the trigger assembly with a thumb, while using the remaining fingers of the grasping hand to hold onto the housing 132. As will be explained in greater detail below, actuating the trigger assembly 212 grasps the leash to prevent it from moving through the housing 132.

The operation of the puller 130, specifically the pulling mechanism 160 and the trigger assembly 212, is illustrated in FIGS. 10-13. As shown in FIGS. 10 and 12, the trigger assembly 212 is not depressed and the teeth of the first locking element 188 face away from the teeth of the second locking element 190. As such, in this first position, the leash can freely move through the first and second generally tubular members 174, 176 of the puller 130. To prevent the cap button 216 from falling out of the puller 130, flanges 231 and 232 protrude from the lower end of the cap button, as can be seen in FIG. 10. These cooperate, respectively, with a tab 233 and a wall of the housing 132.

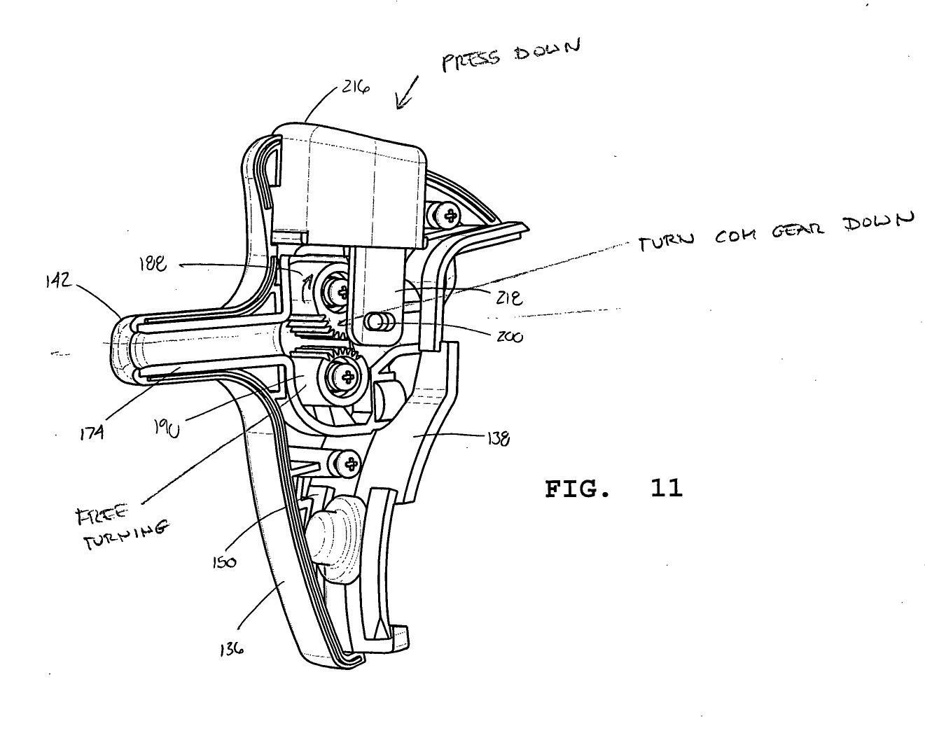

As shown in FIGS. 11 and 13, the trigger assembly 212 is fully depressed. As the trigger assembly is being depressed, the arms 218 of the cap 214 will move the pegs 200 downward in the arcuate slots. This downward movement causes the first locking element 188 to rotate about the boss 170 which, in turn, causes the teeth of the first locking element to grab the leash extending through the puller 130 and press the leash against the teeth of the second locking element 190. In this fully depressed second position, the teeth of the first locking element 188 face the teeth of the second locking element 190 and the leash is prevented from moving through the first and second generally tubular members 174, 176 of the puller 130. It should be appreciated that other means for preventing movement of a leash relative to the puller 130 could also be used. For example, the locking elements could be provided with other known types of gripping surfaces, such as a knurled surface or a rubber material.

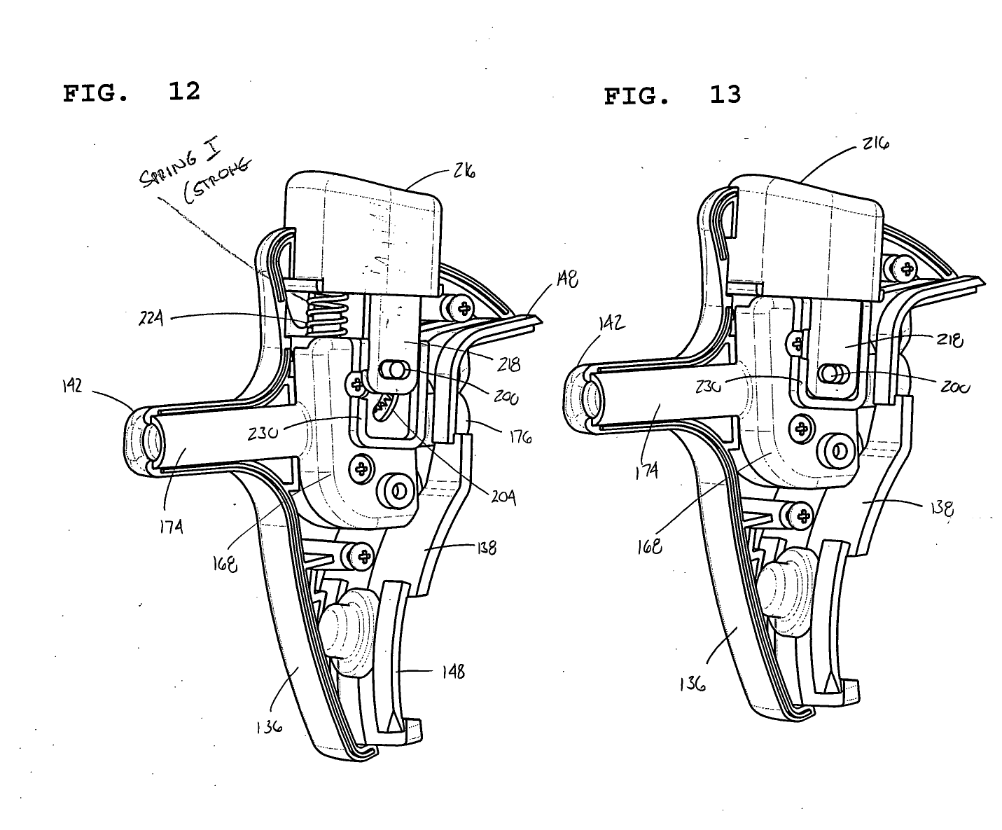

The operation of the puller 130 coupled with the retracting pet leash 10 is illustrated in FIGS. 14-19.

As shown in FIG. 14, the puller can be magnetically secured to the front facing portion of the retracting pet leash. In particular, and as shown in FIG. 2, the front facing portion of the housing 14 includes an opening 234 dimensioned to receive a first magnet 236 and the anti-wear ring 36 includes an opening 238 dimensioned to receive a second magnet 240. As shown in FIGS. 8 and 9, the puller mechanism housing 162 includes a recess 246 dimensioned to receive a third magnet 248 and the back plate 138 includes a recess 250 dimensioned to receive a fourth magnet 252. As the puller 130 approaches the retracting pet leash 10, the first magnet 236 is attracted to the third magnet 248 and the second magnet 240 is attracted to the fourth magnet 252.

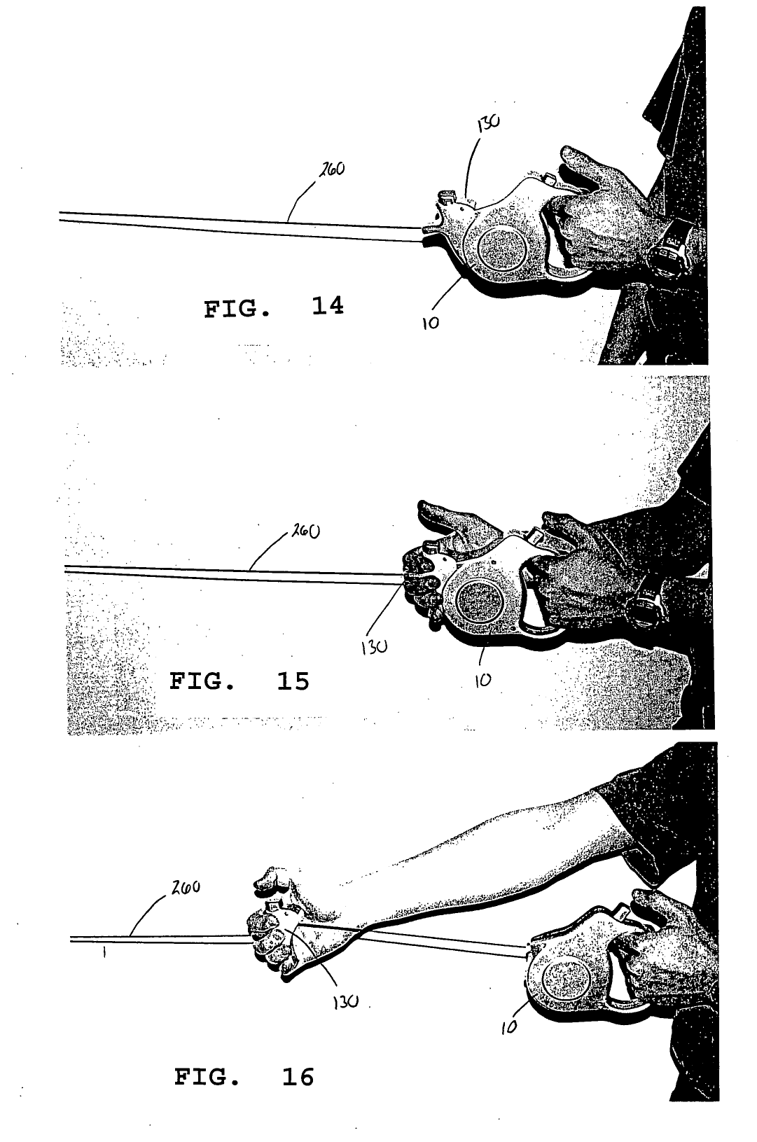

With continued reference to FIG. 14, and additional reference to FIGS. 15 and 16, the leash 260 is freely moving through the puller 130 and the spool (not shown) is freely rotating in the retracting pet leash 10. To retract the leash with the puller 130, the user releases the puller 130 from the retracting pet leash 10 and moves the puller generally an arm length distance from the retracting pet leash.

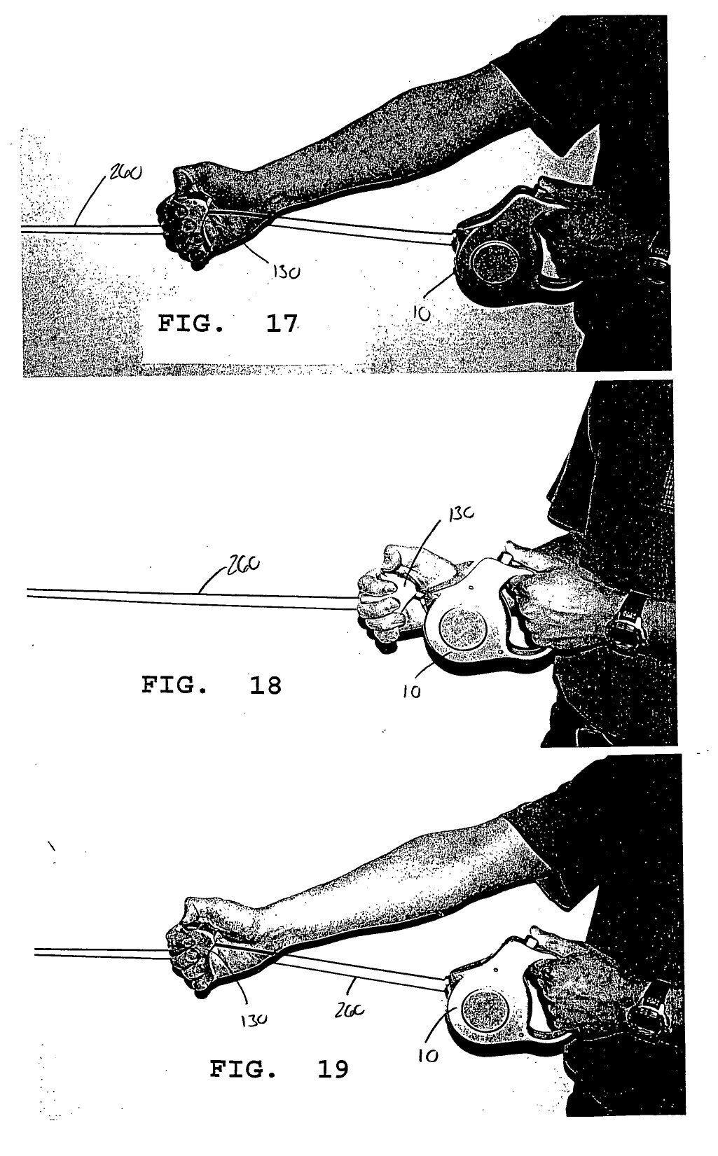

As shown in FIG. 17, and as previously described with reference to FIGS. 4 and 5, the user partially depresses the trigger assembly 40 of the retracting pet leash 10 thereby placing the trigger assembly in partial engagement with the spool 18. Again, in this position, the leash 260 can retract but will not extend any farther from the housing 14. The user then depresses the trigger assembly 212 of the puller 130 thereby locking the leash between the first and second locking elements 188, 190 of the puller mechanism 160.

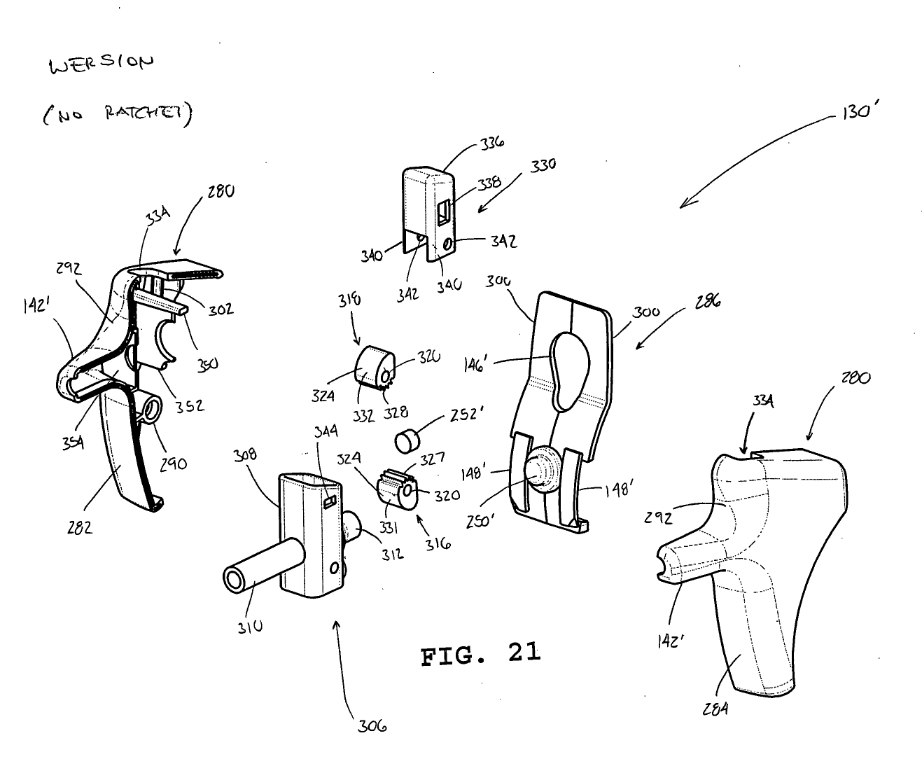

As shown in FIG. 18, the user maintains the trigger assembly 40 in the partially depressed position and with the leash 260 secured in the puller 130, pulls the puller back to the retracting pet leash 10. This, in turn, causes slack in the leash 260 which allows the spool 18 to rotate thereby retracting the leash back into the retracting pet leash 10. It is to be appreciated that the puller 130 is ergonomically shaped to be grasped and operated with one hand. More particularly, a user's index finger is located above the stem 142, while the thumb operates the trigger assembly 212 and the other three fingers hold the bottom half of the puller 130.

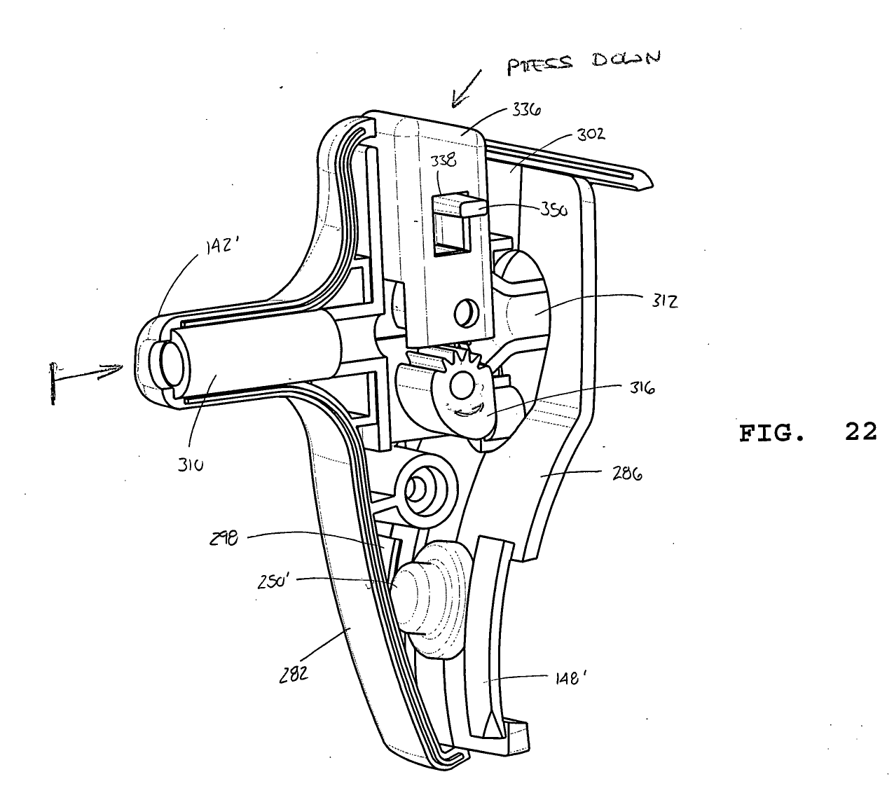

As shown in FIG. 19, the user, again maintaining the trigger assembly 40 of retracting pet leash 10 in the partially depressed position, and the trigger assembly 212 of the puller 130 in the depressed position, moves the puller a distance from the retracting pet leash. In other words, while some friction will be encountered, the user does not need to release the trigger assembly 212 when moving the puller 130 forward on the leash 260 because as the puller is being moved forward, the first locking elements 188 will rotate causing the teeth of at least the first locking element to disengage the leash. As the user starts to pull the puller 130 back towards that retracting pet leash 10, the first locking element 188 will rotate back, again locking the leash between the first and second locking elements 188, 190 of the puller mechanism 160. The user can then pull the puller 130 back to the retracting pet leash 10.

Similar to the first embodiment of the puller 130, a second embodiment of the puller is shown in FIGS. 20-23. Since some of the structure and function is substantially identical to the first embodiment, reference numerals with a single primed suffix (′) refer to like components (e.g., puller 130 is referred to by reference numeral 130′), and new numerals identify new components in the additional embodiment of FIGS. 20-23.

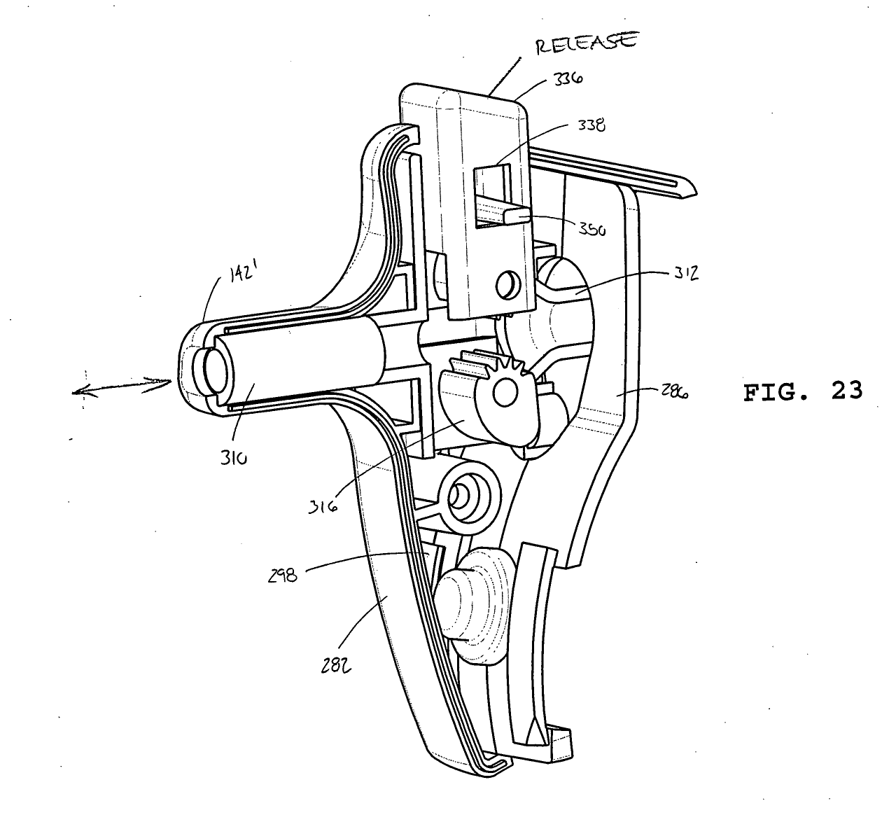

With reference to FIG. 21, the puller 130′ includes a housing 280, which can be a plastic molded component, including first and second halves 282 and 284 and a back plate 286. The housing halves may be secured together by suitable fasteners. In this embodiment, a pair of corresponding bosses 290 extend outwardly from the housing halves 282, 284, each boss including an aperture for receiving a fastener (not shown) which threadingly engages the aperture. The housing 280 further includes a hollow stem 142′ extending outwardly from a forward facing portion 292.

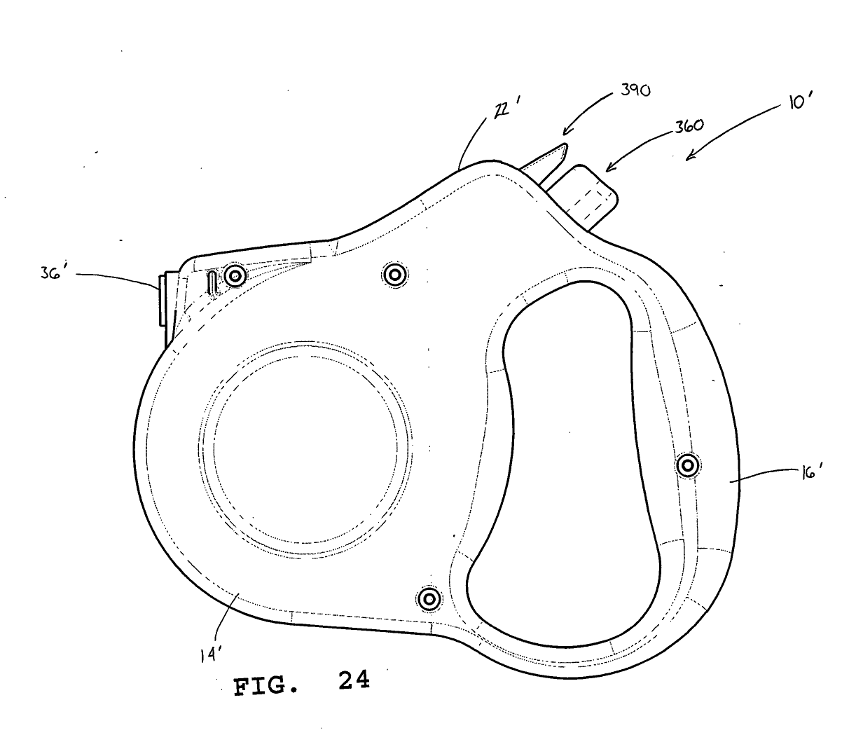

The back plate 286 has a contour conforming to the forward facing portion of the housing 14 and includes an opening 146′ dimensioned to receive a portion of the anti-wear ring 36. With additional reference to FIGS. 22 and 23, to mount the back plate 286 to the housing halves 282, 284, the back plate is provided with thin walled portions 148′ which are dimensioned to be received in a corresponding first slot 298 located on each hosing half. Top edge portions 300 of the back plate 286 are received in a corresponding second slot 302 located on each hosing half. Similar to the first embodiment of the puller, the back plate further includes a recess 250′ dimensioned to receive a magnet 252′ for magnetically attaching the puller 130′ to the retracting pet leash 10.

With continued reference to FIG. 21, the puller 130′ further comprises a puller mechanism 306, which can be a plastic molded component. The puller mechanism includes a generally hollow housing 308 having first and second generally tubular members 310 and 312, respectively, extending outwardly from respective forward and rear facing portions of the housing. It should be appreciated that the first and second tubular members have coincident center axes and an inner diameter dimensioned to slidingly receive the leash (not shown). When a belt-type leash is used, the members 310 and 312 can be generally rectangular in shape, as mentioned above. The first tubular member 310 is received in the hollow stem 142′. The second tubular member 312 projects outwardly from the opening 146′ of the back plate 286 into the opening of the anti-wear ring 36.

The puller mechanism 306 further comprises a first locking element 316 and a second locking element 318. Each locking element includes an opening 320 dimensioned to receive a pin (not shown). Each locking element further includes an outer surface 324 having teeth disposed circumferentially about a portion of the outer surface. The first locking element 316 is secured in the housing 280 via the pin which extends through an aperture (not visible) in one side wall of the housing, the opening 320 in the locking element and a corresponding aperture in the opposing side wall. Once secured, the teeth of the first locking element 316 generally face upward. As will be described in greater detail below, the second locking element 318 is secured to a trigger assembly 330.

With reference again to FIG. 21, the housing 280 further includes an opening 334 provided for passage of the trigger assembly 330 operatively mounted to the housing 280. The trigger assembly includes a cap button 336 which extends outwardly from the opening 334. The cap button includes an opening 338 and a pair of downwardly extending arms 340 having apertures 342. The second locking element 318 is secured in the cap button 336 via the pin (not shown) which extends through the aperture 342 in one side wall of the cap button 336, the opening 320 in the second locking element and the corresponding aperture 342 in the opposing side wall. Once secured, the teeth of the second locking element 318 face the teeth of the first locking element 316.

To assemble the puller 130′, the first locking element 316 is first secured in the housing 308. A spring (not shown) is positioned in the cap button 336. As mentioned above, the second locking element is then secured in the cap button. The assembled trigger assembly is slid into the hollow housing 308 such that the openings 338 of the cap button match openings 334 located in the housing. This assembly is then mounted in the first housing half 282. In particular, the first housing half includes a finger 350 and a pair of tabs 352 and 354, each tab having an arcuate cutout for the respective fist and second generally tubular members 310 and 312. The finger 350 is dimensioned to extend through the openings 344 in the housing 308 and the openings 338 in the cap button 336. As such, the finger will compress the spring located in the cap button thereby biasing the cap button relative to the housing 308. The first housing half 282 is then secured to the second housing half 284 by the fastener (not shown).

The operation of the puller 130′ is illustrated in FIGS. 22 and 23. In FIG. 22, the trigger assembly 336 is shown fully depressed. As the trigger assembly is being depressed, the teeth of the second locking element 318 grab the leash extending through the puller 130′ and press the leash against the teeth of the first locking element 316. In this fully depressed second position, the leash is prevented from moving forwardly through the first and second generally tubular members 310, 312 of the puller 130′. However, the leash can move rearwardly through the members 310, 312 since the locking elements 316 and 318 will rotate so that respective teeth 327 and 328 do not engage the leash. Rather, respective smooth surface 331 and 332 will contact the leash. While some friction will be encountered, the leash will be allowed to slide in that direction.

As shown in FIG. 23, the trigger assembly 330 is not depressed and the teeth of the first locking element 316 are spaced from the teeth of the second locking element 318. As such, in this position, the leash can freely move through the first and second generally tubular members 310, 312 of the puller 130′.

As to a further discussion of the manner of usage and operation of the second embodiment of the puller 130′, the same should be apparent from the above description relative to the first embodiment. Accordingly, no further discussion relating to the manner of usage and operation will be provided.

Similar to the first embodiment of the retracting pet leash 10, a second embodiment of the retracting pet leash is shown in FIGS. 24-27. Since some of the structure and function is substantially identical, reference numerals with a single primed suffix (′) refer to like components (e.g., retracting pet leash 10 is referred to by reference numeral 10′), and new numerals identify new components in the additional embodiment of FIGS. 24-27.

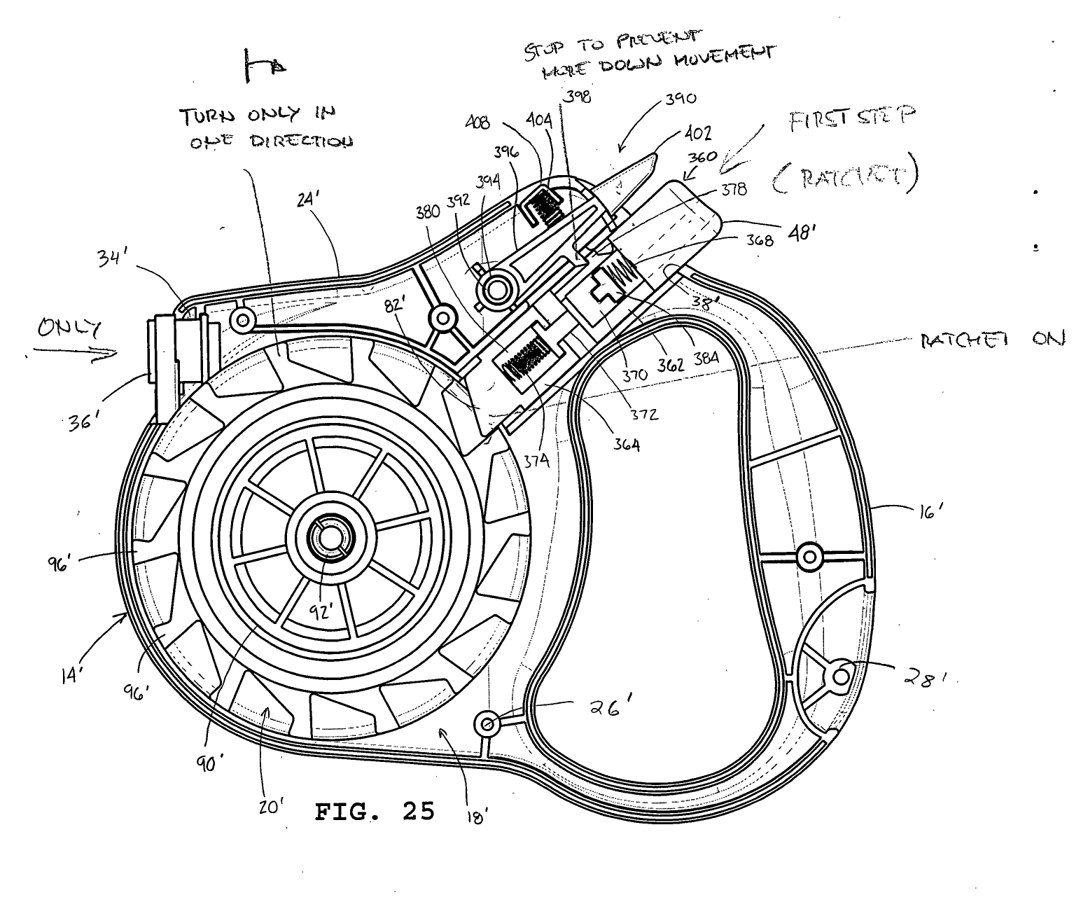

With reference to FIG. 24, the retracting pet leash 10′ generally includes a length of leash (not shown), and a housing 14′. The housing 14′ includes an ergonomical handle or hand grip portion 16′ which can be integrally fabricated with the housing. As shown in FIG. 25, the retracting pet leash 10′ further includes a spool 18′ which houses a portion of a spooling mechanism 20′. Such spooling mechanism enables the extension and retraction of the leash.

The housing 14′ can be a plastic molded component and includes first and second halves 22′ (FIG. 24) and 24′ that may be secured together by suitable fasteners. Similar to the first embodiment, a plurality of corresponding first bosses 26′ extend outwardly from the housing halves, each first boss including an aperture for receiving a fastener (not shown) which threadingly engages the aperture. A pair of second bosses 28′ extends outwardly from an opening 30′ located in the handle portion 16′, each second boss including an aperture for receiving a pin (not shown).

A leash opening 34′ is provided in a forward facing portion of the housing 14′ to enable unhindered movement of the leash between the interior and exterior of the housing. An anti-wear ring 36′, which can be made from a lubricious material, such as nylon, can be mounted in the leash opening 34′ for buffering the leash through the opening 34′ to reduce the frictional wear on the leash due to the leash rubbing against the portion of the housing 14′ defining the opening 34′.

With continued reference to FIG. 25, the housing 14′ further includes an opening 38′ provided for passage of a trigger assembly 360 operatively mounted to the housing 14′ that can engage the spool 18′. The trigger assembly includes a generally rectangular member 362 and an inhibitor 364. Extending from a top wall of the rectangular member is a cap (not visible) dimensioned to receive a cap button 48′. The cap and the cap button extend outwardly through the opening 38′ of the housing 14′. A first button (not visible) extends from a bottom surface of the cap. A first spring 368 for biasing the trigger assembly 360 has a first end attached to the first button and a second end secured to a finger 384 located in a channel 370 extending through the rectangular member 362. Extending from a bottom wall of the rectangular member 362 is a generally T-shaped projection 372 including a button (not visible). A second spring 374 is secured on the button for biasing the inhibitor 364 in and out of engagement with the spooling mechanism 20′. A flange 378 extends generally normal from a side wall of the rectangular member 362.

As shown in FIG. 25, the inhibitor 364 includes a channel 380 dimensioned to receive the generally T-shaped projection 372 of the rectangular member 362 and a pair of tabs 82′ (only one of which is visible), the tabs extending generally normal from a bottom wall of the inhibitor 364. Similar to the first embodiment of the retracting pet leash 10, the tabs engage the spooling mechanism 20′ thereby preventing the free rotation of the spooling mechanism. Thus, actuating the trigger assembly 360 inhibits the leash from being pulled out of the housing 14′.

To assemble the trigger assembly 360, the second spring 374 is mounted onto the button (not visible) of the generally T-shaped projection 372. The rectangular member 362 is then mounted to the inhibitor 364 by sliding the generally T-shaped projection 372, including the attached second spring 374, into the channel 380 of the inhibitor. This allows the inhibitor 364 to bias relative to the rectangular member 362. The trigger assembly is positioned in the opening 38′ defined by the housing halves 22′ and 24′ such that the finger 384 extends outwardly from the second housing half 24′ projects through the channel 370. A first end of the first spring 368 is then attached onto the button (not visible) of the cap (not visible) and a second end of the first spring abuts the finger 384. The cap button 48′ is then positioned onto the cap.

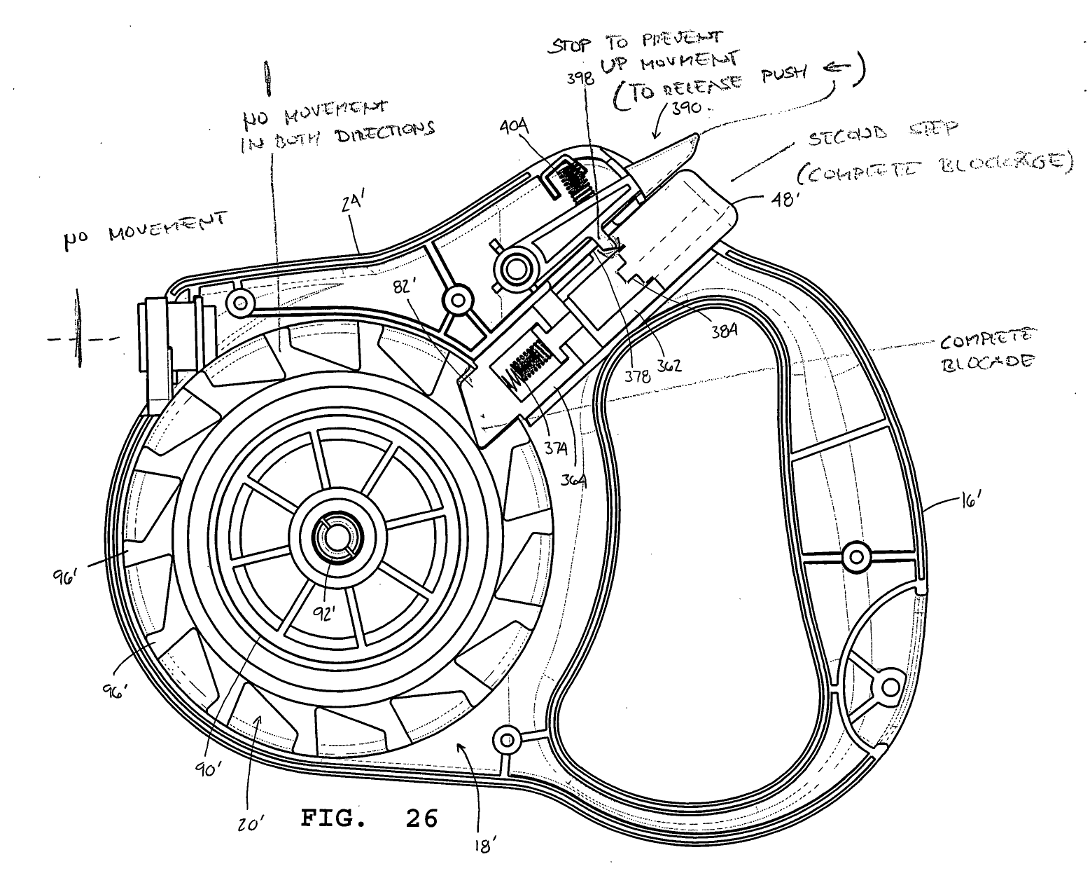

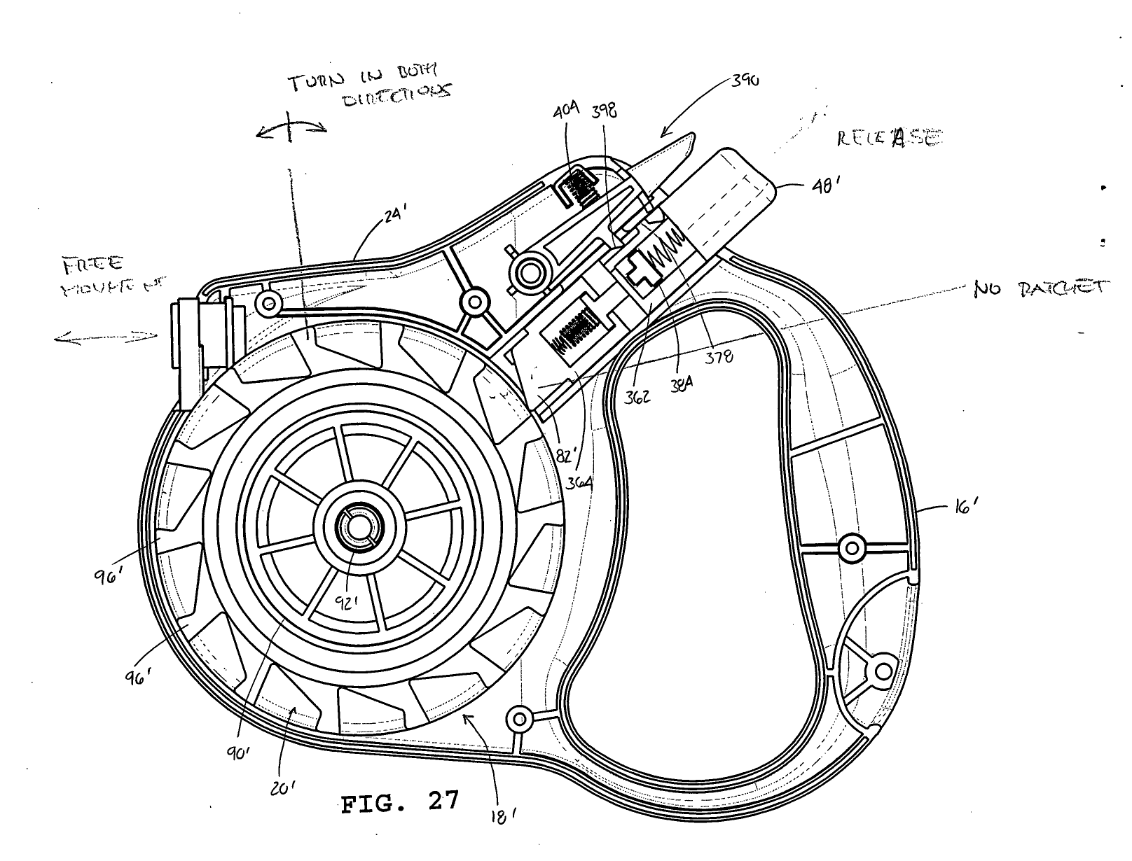

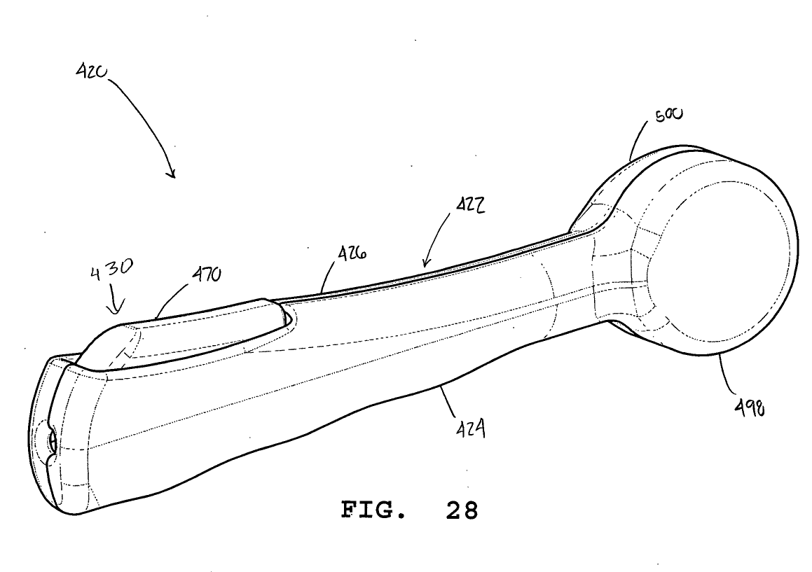

In this embodiment, a separate stop lock button 390 is mounted to the housing 14′ adjacent the trigger assembly 360 such that when a user is gripping the handle portion 16′, the stop lock button may be activated by a finger of the same hand holding the handle portion. The stop lock button 390 is pivotally mounted on 392 extending outwardly from the second housing half 24′. In particular, the stop lock button includes a pivot member 394 secured to the post 392 and an arm 396 extending from the pivot member. The arm 396 includes a stop tab 398 extending from a first surface, a button (not visible) extending from a second surface and a cap 402 which extends outwardly from the opening 366 of the housing 14′. A compressed third spring 404 is secured at one end in a generally U-shaped channel 408 also extending outwardly from the second housing half 24′ and at the other end to the arm button. With reference now to FIG. 27, in an unlocked position, the stop tab 398 is located below the flange 378 of the rectangular member 362. As the trigger assembly 360 is depressed, the stop lock button 390 is moved forward thereby allowing the flange 378 to move below the stop tab 398, as shown in FIG. 26. The third spring 404 will then cause the stop lock button to move backward, the stop tab 398 being located above the flange 378. Thus, the leash stop lock button 390 can lock the trigger assembly 360 in the fully depressed state thereby locking the inhibitor 364 into engagement with the spooling mechanism 20′ which restricts the rotation of the spool 18′.

With continued reference to FIGS. 25-27, and as more fully described with reference to the first embodiment of the retracting pet leash 10, the spooling mechanism 20′ includes a power spring (not shown) and a spool cover 90′. A stationary axle 92′ extends from the housing half 24′. The spool cover 90′ fastens over the power spring to secure the power spring in a spool cavity. The spool 18′ includes several teeth 96′ spaced around the circumference of an outer facing portion and the circumference of an inner facing portion of the spool. The teeth 96′ are adapted for engaging the pair of tabs 82′ and 84′ of the inhibitor 364 of the trigger assembly 360.

The operation of the trigger assembly 360, the spool 18′ and the stop lock button 390 is illustrated in FIGS. 25-27. As shown in FIG. 25, the trigger assembly 360 is only partially depressed. In this position, the flange 378 of the rectangular member 362 abuts against the stop tab 398 of the stop lock button 390. The teeth 96′ of the spooling mechanism 20′ are not fully engaged by the pair of tabs 82′ and 84′ of the inhibitor 364. In this position, the spool 18′ is free to rotate in a clockwise direction, the second spring 374 biasing the inhibitor 364 in and out of engagement with the teeth 96′, but is prevented from rotating in a counterclockwise direction. As such, the leash can retract but will not extend any farther from the housing 14′.

As shown in FIG. 26, the trigger assembly 360 is fully depressed. In this position, flange 378 of the rectangular member 362 is located below the stop tab 398. Thus, the flange 378 abuts a bottom surface of the stop tab 398 thereby locking the trigger assembly 360 into engagement with the spooling mechanism 20′. The teeth 96′ of the spooling mechanism 20′ are fully engaged by the pair of tabs 82′ and 84′ of the inhibitor 44. As such, the spool 18′ is prevented from rotating in either a clockwise direction or a counterclockwise direction.

As shown in FIG. 27, the trigger assembly 360 is not depressed and first and second tabs 82′, 84′ of the inhibitor 364 is spaced from the teeth 96′ of the spooling mechanism 20′. As such, in this position, the spool 18′ can freely rotate in the housing 14′ in both clockwise and counterclockwise directions.

A third embodiment of a puller 420 according to the present invention is illustrated in FIGS. 28-30.

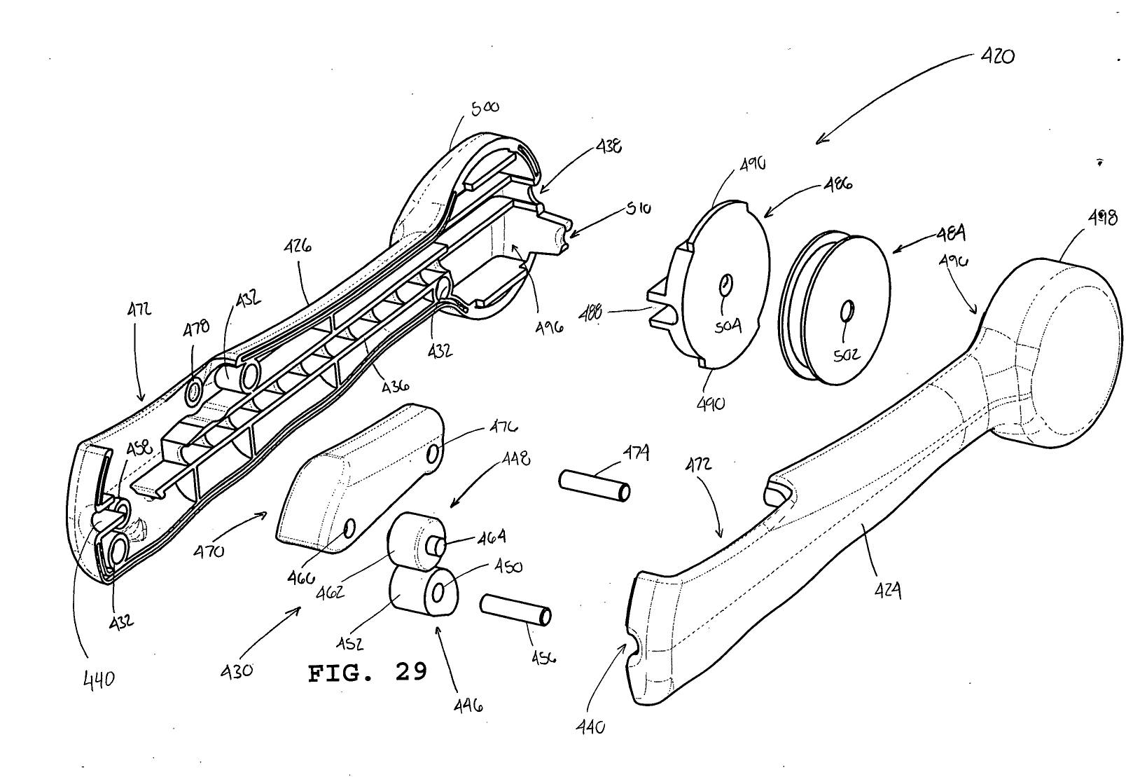

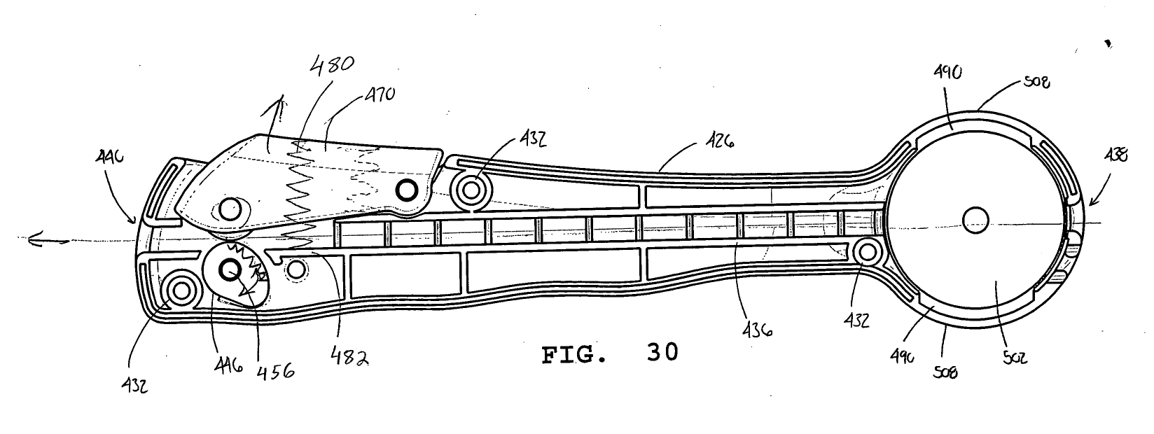

As shown in FIG. 28, the puller 420 comprises a housing 422, which can be a plastic molded component, including first and second halves 424 and 426 and a trigger assembly 430. The housing halves may be secured together by suitable fasteners. To this end, as shown in FIG. 29, a plurality of corresponding first bosses 432 extend outwardly from the housing halves 424, 426, each boss including an aperture for receiving a fastener (not shown) which threadingly engages the aperture. The housing 422 further includes a leash channel 436 generally disposed between a first opening 438 and an opposing second opening 440. It should be appreciated that the first and second openings have coincident center axes and an inner diameter dimensioned to slidingly receive the leash (not shown). When a belt-type leash is used, the leash channel 436 and the opening 438 can be generally rectangular in shape, as mentioned above.

The puller 420 further comprises a first locking element 446 and a second locking element 448. The first locking element 446 includes an opening 450 and an outer surface 452 having teeth disposed circumferentially about a portion of the outer surface. With particular reference to FIG. 30, the first locking element 446 is mounted on a first pin 456 which extends through the opening 450. Opposing ends of the first pin are, as shown in FIG. 29, secured in apertures of a pair of second bosses 458 extending outwardly from the housing halves 424, 426.

The second locking element 448 also includes an outer surface 462 having teeth disposed circumferentially about a portion of the outer surface. As shown in FIG. 29, a pair of pegs 464 extends outwardly from opposing faces of the second locking element. The pegs 464 are received in corresponding first apertures 466 located on a trigger 470. FIG. 30 illustrates that the second locking element is rotationally mounted to the trigger 470.

With reference again to FIG. 29, the housing 422 further includes an opening 472 provided for passage of the trigger 470, which is pivotally mounted to the housing via a second pin 474. In particular, the second pin extends through second apertures 476 located on the trigger 470. One end of the second pin 474 is secured in an aperture 478 disposed near the opening 472 of the second housing half 426 and the other end being secured in a recess (not shown) disposed near the opening 472 of the first housing half 424. As shown in FIG. 30, a compressed spring 480 is positioned between a top surface of the trigger and an abutment surface 482 below the channel 436. The compressed spring 480 biases the trigger 470 outwardly from the opening 472 of the housing 422. The spring is spaced to one side of the leash in the channel 436 so as not to interfere with it.

With reference again to FIG. 29, the puller 420 further includes a spool 484 and a leash guide 486. The leash guide 486 includes a channel 488 having an inlet adjacent the first opening 438 of the housing 422 and an outlet adjacent an inlet of the leash channel 436. A pair of tabs 490 extends diametrically from the guide 486. Both the spool 484 and the guide 486 are mounted in a recess 496 defined by generally round first and second end portions 498 and 500, respectively, of the first and second housing halves 424, 426. A peg (not shown) extends outwardly from the first round portion 500, the peg extending through a spool aperture 502 and a guide aperture 504. It should be appreciated that while the spool is rotationally mounted on the peg, the guide is fixedly mounted due to the tabs 490 being positioned in corresponding diametrically opposed offsets 508 located in the first round portion 500 (FIG. 30).

As shown in FIG. 30, the trigger 470 is fully depressed. As the trigger is being depressed, the second locking element 448 pushes the leash extending through the puller 420 down against the teeth of the first locking element 446. In this fully depressed second position, the leash is prevented from moving forwardly through the leash channel 436 of the puller 470′. However, the leash can move rearwardly through the leash channel since the first and second locking elements 446 and 448 will rotate so that respective teeth of the locking elements do not engage the leash. Rather, respective outer surfaces 452 and 462 of the locking elements will contact the leash. While some friction will be encountered, the leash will be allowed to slide in that direction. As the trigger is released, the compressed spring 480 biases the trigger away from the first locking element 446 such that the second locking element stops pushing the leash against the teeth of the first locking element 446. In this position, the leash can freely move through the leash channel 436.

If desired, the puller 420 can be magnetically attached to the retracting pet leash. In particular, a first magnet (not shown) can be fixedly secured to one of the first and second end portions 498 and 500, such magnet being attracted to a corresponding second magnet (not shown) attached to the retracting pet leash. Alternatively, the first magnet can be attached to an end of a cord (not shown) wound on the spool 484, the cord extending from an opening 510 (FIG. 29) defined by the first and second end portions 498 and 500. Again, the first magnet will be attracted to a corresponding second magnet attached to the retracting pet leash. As the puller 430 is moved away from the retracting dog leash, the cord will extend from the puller and the first and second magnets will remain attached to each other. As the puller 430 is moved back towards the retracting dog leash, the cord will wind around the spool 484. As such, during operation, the puller remains attached to the retracting dog leash.

As to a further discussion of the manner of usage and operation of the third embodiment of the puller 420, the same should be apparent from the above description relative to the first embodiment. Accordingly, no further discussion relating to the manner of usage and operation will be provided.

The disclosure has been described with reference to several embodiments. Obviously, modifications and alterations will occur to others upon reading and understanding the preceding detailed description. It is intended that the disclosure be construed as including all such modifications and alterations insofar as they come within the scope of the appended claims or the equivalents thereof.

What is claimed is:

1. A puller operably connected to an associated pet leash for enabling a pet owner to retract the associated pet leash, the puller comprising:
a housing;
a first locking element mounted in the housing;
a second locking element mounted in the housing, said second locking element being spaced a predetermined distance from said first locking element to allow the associated pet leash extending through said housing to pass therebetween; and
a trigger assembly operatively mounted to said housing, a first portion of said trigger assembly engaging said first locking element,
wherein, as said trigger assembly is depressed, said first locking element engages the associated pet leash and presses the associated pet leash against said second locking element thereby preventing movement of the associated pet leash through the puller, in at least a first direction.

2. The puller of claim 1, wherein each locking element has an outer surface with a gripping portion disposed circumferentially about a portion of the outer surface.

3. The puller of claim 2, wherein a portion of the outer surface of each locking element is generally smooth, wherein as said first locking element engages said second locking element and the associated pet leash is pulled in a second first direction, at least one of said first and second locking element rotates allowing the associated pet leash to move through the puller in said second direction.

4. The puller of claim 1, wherein said first locking element is rotatably mounted to said trigger assembly.

5. The puller of claim 4, wherein said second locking element is rotatably mounted in said housing.

6. The puller of claim 4, wherein said second locking element is fixedly mounted in said housing.

7. The puller of claim 1, wherein said housing includes a channel extending at least partially through said housing, said channel being dimensioned to slidingly receive the associated pet leash.

8. The puller of claim 1, wherein the puller further includes at least one magnet mounted to said housing for releasably connecting the puller to an associated pet leash assembly.

9. The puller of claim 1, further including a lock for said trigger assembly, to lock said trigger assembly in one position.

10. The puller of claim 9, wherein lock comprises a lock housing mounted in said housing, said lock housing including a first section configured to operably receive said first portion of said trigger assembly and a second section configured to mount said second locking element, said first section of said lock housing includes a slot adapted to receive a portion of said first locking element, wherein as said trigger assembly is depressed, said slot guides said first locking element into engagement with said second locking element.

11. A puller operably connected to an associated pet leash for enabling a pet owner to retract the associated pet leash, the puller comprising:
a puller housing;
a lock housing mounted to said puller housing, said lock housing including a channel dimensioned to slidingly receive the associated pet leash;
a trigger assembly operatively mounted to said lock housing;
a first locking element rotatably mounted to said trigger assembly; and
a second locking element mounted to said lock housing.

12. The puller of claim 11, wherein each locking element has an outer surface with teeth disposed circumferentially about a portion of the outer surface.

13. The puller of claim 12, wherein one of said first and second locking elements is generally cam-shaped.

14. The puller of claim 13, wherein a lobe of said cam-shaped locking element is configured to move said teeth of said cam-shaped one locking element into engagement with the teeth of another of said first and second locking elements.

15. A retractable pet leash assembly comprising:
a housing;
a spool rotatably mounted to said housing;
a stop member extending from said housing, the stop member including a first surface and a second surface; and
a trigger assembly operably mounted in said housing, the trigger assembly including:
a locking member configured to selectively engage said stop member; and
an inhibitor connected to said locking member, said inhibitor selectively engaging said spool,
wherein in a first position, said locking member is spaced from said stop member, said inhibitor is spaced from said spool, said spool freely rotating within said housing,
wherein in a second position, said locking member engages said first surface of said stop member, said inhibitor at least partially engages said spool and preventing said spool from rotating in a counterclockwise direction,
wherein in a third position, said locking member engages said second surface of said stop member, said inhibitor engaging said spool and preventing said spool from rotating in either a clockwise direction or a counterclockwise direction.

16. The retractable pet leash assembly of claim 15, wherein said locking member includes a projection dimensioned to be received in a channel of said inhibitor.

17. The retractable pet leash assembly of claim 16, wherein said locking member includes a first biasing member disposed between said projection and a wall of said channel, wherein in said second position, said biasing member moving said inhibitor in and out of engagement with said spool.

18. The retractable pet leash assembly of claim 15, wherein said locking member includes a first guide and said housing includes a second guide, wherein as said trigger assembly moves from said second position to said third position, said first guide engages said second guide, said second guide urging said locking member into engagement with said stop member.

19. The retractable pet leash assembly of claim 15, wherein said locking member includes a second biasing member for biasing said trigger assembly outwardly from said housing.

20. The retractable pet leash assembly of claim 15, further including a lever, said lever being pivotally mounted to said housing, wherein in said third position, said lever pivoting said stop member into engagement with said locking member.
